(19) United States
(12) Patent Application Publication
(10) Pub. No.: US 2009/0275010 A1
(43) Pub. Date: Nov. 5, 2009

(54) TELEVISION VIERWERS INTERACTION VOTING

(76) Inventor: MICHAEL Charles FINDLAY, Queens, NY (US)

Correspondence Address: MICAHAEL FINDLAY, PO BOX 573, NEW YORK, NY, 10116, US

(21) Appl. No.: 12/114,775

(22) Filed: May 4, 2008

(51) Int. Cl. G06F 19/00

(52) U.S. Cl. 434/362

(57) ABSTRACT

A multi-talented show idea and voting methods to find a winner in multi-categories of tasks and talents through voting is disclosed. Viewers who vote for their favorite contestant and show via phone or internet has a chance to win a prize. Viewer vote via phone by using at least one of different calling number and same calling number. The future contestants who records a demo after calling to the show is contacted via phone, mail, web or television. A plurality of contestants participating in the show is separated into a plurality of groups that competes to win a spot as finalists. Said finalists and a second chance contestant chosen by the viewers compete in the elimination show called “R-u-Multi-Talented” to become at least one of three contestants for the “Final three showdown”. At least one among said three contestants is announced as winner and is given the title “U-r-Multi-Talented”.

### CROSS-REFERENCE TO RELATED APPLICATION

None

### FEDERALLY SPONSORED RESEARCH

None

### SEQUENCE LISTING OR PROGRAM

None

### BACKGROUND

The invention relates to a show idea, and more particularly to a method of scheduling of event and selecting the best contestant by calling in to vote.

The entertainment industry has been constantly struggling to locate the next big talent. The traditionally accepted method to locate new talent is through talent calls and talent shows. There are dozens of talent competitions today. Most competitions are broadcasted on television for the public to enjoy. The entertainment provided by these competitions is primarily that the viewers can live vicariously through the wins and losses of the participants. A viewer may participate in judging the performance of a contestant that determines the eventual winner. The viewer can vote using various techniques like SMS messaging, cell phone calls or dial-up telephone calls or through internet. As the audition is done by judges who have expertise in a particular area of talent, an eligible contestant may loose his chance to go to the next level of competition.

In presentation of a talent competition, audience and viewership is the key factor that determines the financial success of an event. The revenue in support of the commercial broadcasting is usually derived from advertisements or commercials that accompany the presentation of the program.

Prior art discloses an apparatus and method for analyzing selection criteria for forming a select talent group. The apparatus includes an input device operably coupled to a select talent group selector. The selector can compute the scores of the individuals of only two groups based on selection criteria and audition information. The apparatus includes an output device that has a display that lists the scores. This has the drawback that a person located far from the venue is deprived of his opportunity to vote for his favorite contestant. Moreover, said method can handle only a maximum of two groups.

In the traditional method, a panel of judges tours the country and selects artists from different locations based on individuals who show up to try out. The selected artists are presented in live performance before a national television audience. The audience vote using text messaging for the contestants. Although the public has input into the selection of the winning artist, judges first narrow the field of contestants so that many talented artists are eliminated without a chance for public review.

The prior art multi talent shows and viewer response systems fail to fulfill the viewers needs and are inadequate in finding the right talented contestant. In addition, the current systems are time consuming and difficult in scheduling.

Therefore it is an object of the present method to overcome the shortcomings in the prior art and to provide an efficient method of scheduling of multi-talent shows. It is a further object of the present invention to provide an efficient viewer response method to select their favorite contestant and show. It is a still further object of the present invention to provide viewers who participate in voting with prizes. These and other objects are set forth in the following detailed description.

### SUMMARY

The present invention discloses a multi talent show and voting methods to find the best contestant in multiple categories of tasks and talents like singing, dancing, writing, acting, comedy, coking, modeling and selling a car. The viewers choose their favorite contestant's each show by calling in to vote. The winner is awarded cash and prizes.

At least one hundred contestants participate in a single multi-talented show. Said contestants are separated into at least ten groups with each group consisting of at least ten contestants. The plurality of groups competes to win a spot as finalists. The contestants are taken to the next level by voting. Viewers vote via phone or internet on talent categories they would like to see their contestant's perform. Said finalists and a second chance contestant chosen by the viewers compete in the elimination show called “R-u-Multi Talented”. At least one contestant is eliminated after completing at least one show of a plurality of shows in the elimination show. The contestants are eliminated based on the votes they have received. Said procedure continues until, at least three contestants are left for “Final three showdown”. The winner, announced on the final show, is given the title “U-r-Multi-Talented”.

A viewer votes via phone by using at least one of different calling number and same calling number. Not only the viewers vote for their favorite contestant but also select their favorite show. Each voter has a chance to win a prize. A contestant who wishes to participate in the show makes a call to the show and records a demo whereby the state files the information of said contestants. These future contestants are contacted via phone, mail, web or television.

Although particular embodiments of the present invention have been described in the foregoing description, it is to be understood that the present invention is not to be limited to just the embodiments disclosed, but that they are capable of numerous rearrangements, modifications and substitutions without departing from the description herein.

### BRIEF DESCRIPTION OF THE DRAWINGS

FIG. 1 is a block diagram illustrating a method of selection of a winner in the multi-talented show.

FIG. 2 is a block diagram illustrating a method of voting for a talent and task singing of a contestant using different calling number call.

FIG. 3 is a block diagram illustrating a method of voting for talent and task dancing of a contestant using different calling number call.

FIG. 4 is a block diagram illustrating a method of voting for a contestant using same calling number call.

FIG. 5 is a block diagram illustrating a calling system for a future contestant.

### REFERENCE NUMERALS

10 . . . Phases for selecting a winner
11 . . . First phase of selection
12 . . . Second phase of selection
13 . . . Third phase of selection
14 . . . Fourth phase of selection
15 . . . Final phase of selection

### DETAILED DESCRIPTION

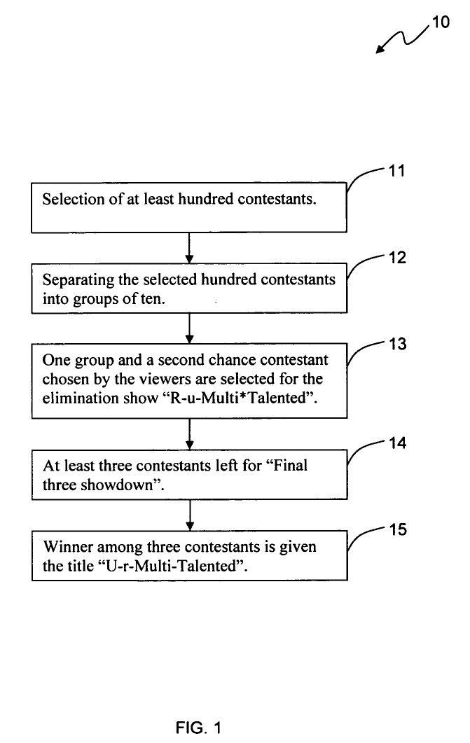

FIG. 1, provides a flow chart explaining the steps involved in the method of selection of a winner in a multi-talent show. As said in the block 11, at least one hundred contestants are selected initially for a single show from among the ones who recorded the demo by calling. Then, as illustrated in block 12, said selected contestants are separated into groups of ten. Contestants in said groups compete to win a spot as finalists. A contestant participates in at least seven different talent categories. Viewers vote via phone or internet on talent categories they would like to see there contestant's perform.

At least one group among the ten groups is selected for the next round. As illustrated in block 13, said selected group and a second chance contestant, chosen by the viewers, compete in the elimination show called “R-u-Multi-Talented”. At least one contestant is eliminated after completing at least one show of a plurality of shows in the elimination show. The contestants are eliminated based on the votes they have received. As illustrated in block 14, said procedure continues until, at least three contestants are left for “Final three showdown”. The winner, announced on the final show, is given the title “U-r-Multi-Talented”.

The show is advertised via television and internet. A viewer can vote via phone by using at least one of different calling number call and same calling number call.

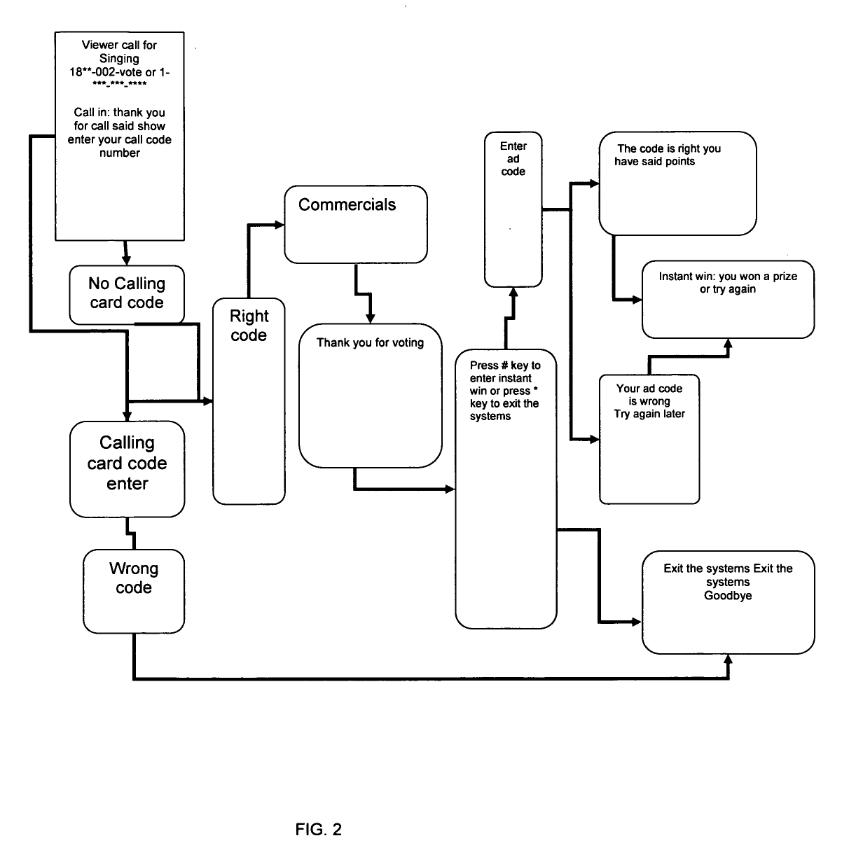

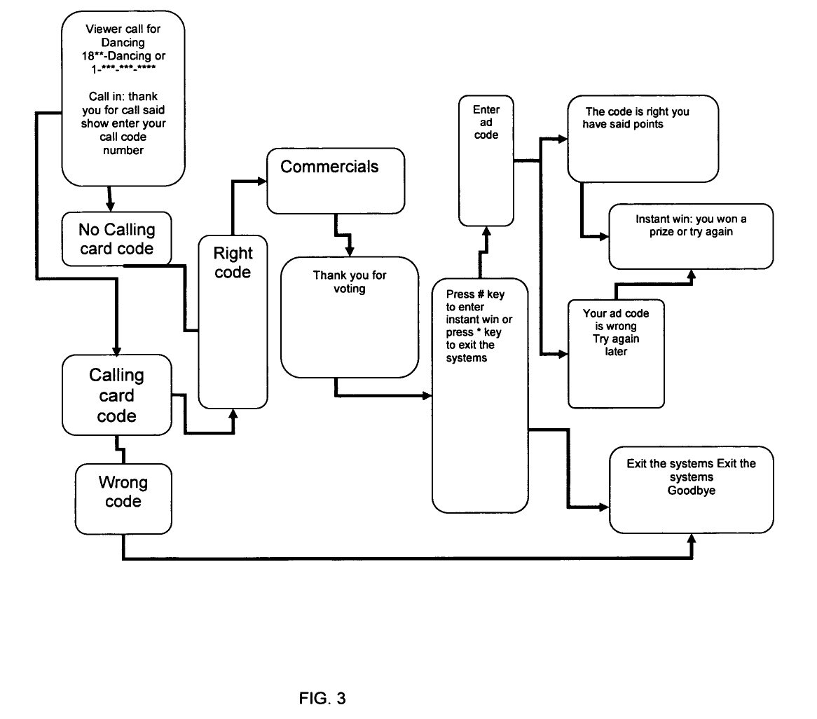

FIG. 2 and FIG. 3 illustrate a flow chart explaining the steps involved in voting via different calling number call for singing and dancing respectively. The viewer makes a call for a particular show and enters the call code. The viewer then enters the calling card code. Failure to enter the calling card code or entering the wrong calling card code, exits the viewer from the system. The vote is registered after commercials. Pressing the * key exits the viewer from the system. Pressing the # key enters the viewer into instant win that may awards the viewer with a prize depending on the ad code he/she has entered.

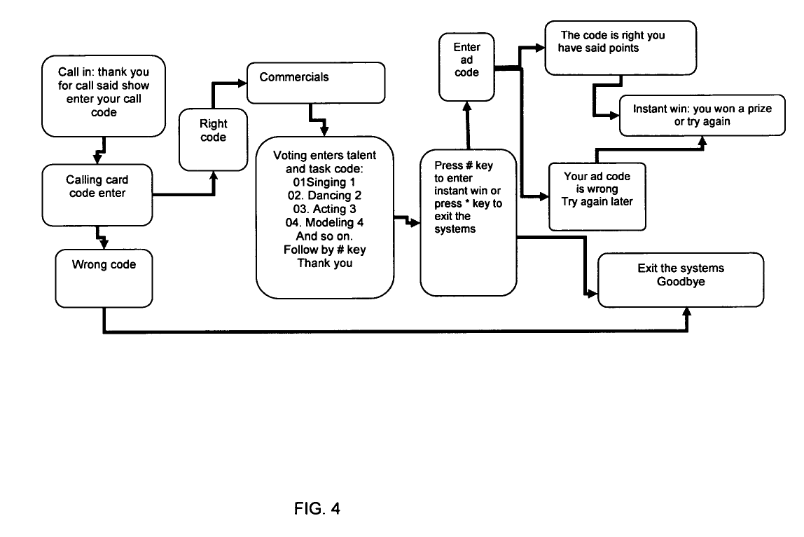

Referring to FIG. 4, illustrates a flow chart explaining the steps involved in voting via same calling number call. The viewer enters the call code after making a call to the show. Then, the calling card code is entered, whereby the right code leads to commercials and the wrong code exits the caller from the system. After the commercials, the talent code is entered followed by # key. On pressing either the # key or the * key leads the caller to instant win or exit to the system respectively. The caller enters the ad code after pressing the # key. The caller may be offered a prize when the right ad code is entered.

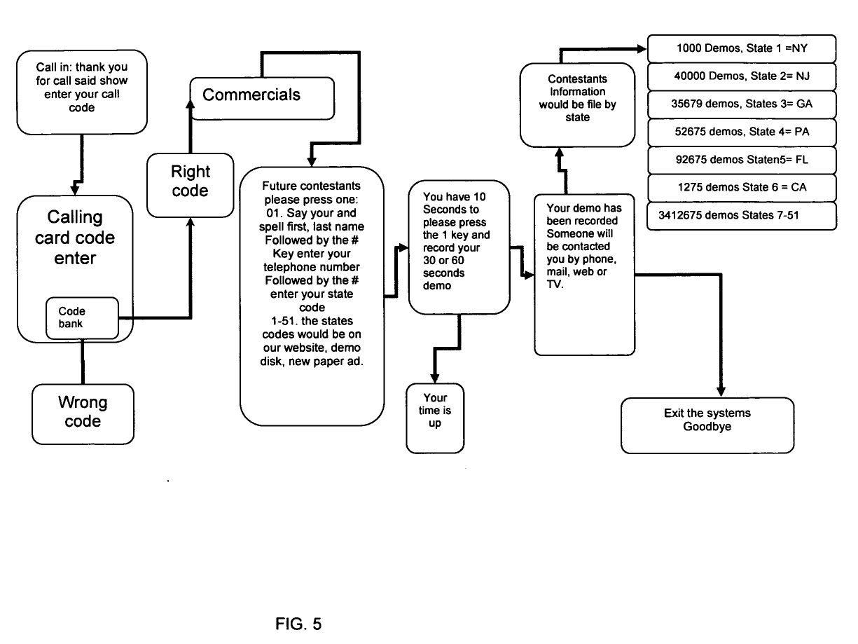

FIG. 5 illustrates a block diagram explaining the steps involved in future contestants calling systems. Here, the caller makes a call to the show and enters the call code. Then, the calling card code is entered where said code is verified in a code bank and the right code leads the caller to commercials. After commercials, the caller or the future contestant presses the numeric-1 key. He/She say and spell the first and last name. The caller then enters the # key followed by telephone number. The caller then enters the # key followed by the state code. The state codes are available on the website, demo disk and newspaper ad. The numeric-1 key is pressed within ten seconds and the future contestant records 30 or 60 seconds demo. Failure to press the numeric-1 key exits the caller from the system. The state files the information of future contestants. The contestants who have recorded demos are contacted via phone, mail, web or television.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A multi talent show and voting methods to find a winner in multiple categories of tasks and talents comprising:
a plurality of contestants;
a plurality of groups; and
a plurality of voting methods.

2. The method of claim 1, wherein a contestant participates in at least seven categories of tasks and talents.

3. The method of claim 1, wherein at least one hundred contestants participate in a single show.

4. The method of claim 1, wherein said contestants are separated into at least ten groups with each group consisting of at least ten contestants.

5. The method of claim 1, wherein said plurality of groups compete to win a spot as finalists.

6. The method of claim 1, wherein a viewer selects a contestant and a show by voting through at least one of phone and internet.

7. The method of claim 1, wherein said finalists and a second chance contestant chosen by the viewers compete in the elimination show called “R-u-Multi Talented”.

8. The method of claim 7, wherein at least one contestant is eliminated during each result shows in said elimination show; based on the votes they have received.

9. The method of claim 7, wherein said elimination show leaves at least three contestants based on the votes they have received, for the “Final three showdown”.

10. The method of claim 7, wherein the announced winner on the final show is given the title “U-r-Multi-Talented”.

11. The method of claim 1, wherein a viewer can vote via phone by using at least one of different calling number and same calling number.

12. A method of voting for a contestant using different calling number call comprises:
making a call for a particular show;
entering the call code;
entering the calling card code number whereby the right code will register the vote;
pressing at least one of # key and * key to enter at least one of instant win and exit to the system respectively;
entering the ad code whereby the right ad code may offer a prize; and
exiting from the system.

13. A method of voting for a contestant using same calling number call comprises:
making a call for a particular show;
entering the call code;
entering the calling card code number;
entering the talent code followed by # key;
pressing at least one of # key and * key to enter at least one of instant win and exit to the system respectively;
entering the ad code whereby the right ad code may offer a prize; and
exiting from the system.

14. A method of calling for a future contestant comprises:
making a call for a particular show;
entering the call code;
entering the calling card code which is verified in a code bank;
pressing the 1 key;
saying and spelling the first and last name of the contestant;
entering the # key followed by telephone number;
entering the # key followed by state code;
pressing the one key within ten seconds;
recording the demo for 30 to 60 seconds; and
exiting from the system.

15. The method of claim 14, wherein the contestant who recorded the demo is contacted by phone, mail, web or television.

16. The method of claim 14, wherein the state files the information of contestants.
